(19) United States
(12) Patent Application Publication
(10) Pub. No.: US 2013/0297492 A1
(43) Pub. Date: Nov. 7, 2013

(54) CHARGEBACK AUTOMATION SYSTEM AND METHOD

(71) Applicant: Digital River, Inc., Minnetonka, MN (US)

(72) Inventors: Michael James Ertresvaag, Farmington, MN (US); Jessica Leigh Bergholtz Burnett, Burnsville, MN (US); David Thomas McFadden, Bloomington, MN (US); Christopher Scott Beaudoin, Elk River, MN (US)

(73) Assignee: Digital River, Inc., Minnetonka, MN (US)

(21) Appl. No.: 13/666,316

(22) Filed: Nov. 1, 2012

Related U.S. Application Data
(60) Provisional application No. 61/554,699, filed on Nov. 2, 2011.

(51) Int. Cl. G06Q 20/38

(52) U.S. Cl. CPC G06Q 20/389
USPC 705/39

(57) ABSTRACT

E-commerce customers may dispute a charge for various reasons. When they dispute a charge with the payment processor, the payment processor reverses the charge and notifies the payment gateway that transacted the payment. An automated chargeback dispute program is scheduled to run each day to collect data for disputing the chargeback notifications. Data is extracted from the payment processing gateway and e-commerce platform that performed the original transaction. The data is formatted into a response, such as a letter, file, or API message and electronically submitted to the issuing bank.

### RELATED APPLICATIONS

This application claims the benefit of U.S. Provisional Application No. 61/545,699 filed 1 Nov. 2011, entitled “Fraud Chargeback Dispute Processing,” which is incorporated herein by reference.

### FIELD OF THE INVENTION

The present invention relates to e-commerce and more particularly, relates to a system and method for processing chargebacks for payment transactions performed in a distributed computing environment over the internet.

### BACKGROUND OF THE INVENTION

A proactive plan to prevent and deal with chargebacks is essential for any business that accepts credit cards. Without an effective plan, chargebacks can result in both revenue loss and expense and could prompt a payment processor to cancel a merchant account.

Chargebacks may occur for a number of reasons. Some common reasons for chargebacks are a customer receiving duplicate or incorrect billing, a refund due that may not be issued or customer dissatisfied with a purchased product. Unfortunately, one of the most common reasons for a chargeback is fraud. A credit card may be used without consent or proper authorization, or a credit card may be used with a chargeback to fraudulently obtain goods. If a customer disputes a charge for a product that they've already received, the merchant stands to lose revenue, profit and product. If the product or service is expensive this combination can amount to a substantial loss. An effective chargeback plan lessens the frequency of chargebacks and increases the likelihood of winning disputes when they are issued.

When a customer disputes a credit card charge, the issuing banks frequently reverse the disputed transactions immediately, prior to receiving any proof to support the claim and prior to contacting the merchant. If the merchant doesn't respond to the issuing bank's chargeback notice within a specified time frame (usually 10 days or less) the cardholder will succeed in abusing the system with a loss to the merchant.

A proactive plan for handling chargebacks is required to quickly and effectively challenge fraudulent chargebacks. The best defensive plan is to maintain thorough sales documentation, including sales receipts, signatures, and proof of delivery for physical products. Since customers that request fraudulent chargebacks have no real proof to support their claim, maintaining complete records greatly increases a merchant's chance of winning a chargeback dispute.

Merchants typically rely on human data collection and investigation of chargeback disputes. Unfortunately, human error is possible and the time it takes for a person to collect the data, create a useful format, and submit it to the credit card company is difficult to do in the time required to address a dispute. An automated chargeback dispute program is required to ensure complete and accurate data collection in the most timely manner. The features of the claimed system and method provide a solution to these needs and other problems, and offers other advantages over the prior art.

### BRIEF SUMMARY

The present system and method are related to a computerized system that solves the above-mentioned problems. A system and method for addressing chargeback disputes is presented. The system consists of at least one of each centralized payment gateway, ecommerce platform, and chargeback dispute server. When customers dispute a charge on their credit card, the issuing bank, or payment processor, sends the payment gateway a notification of a chargeback, or reversal of charges. When the payment gateway receives a chargeback notification a program is run to collect the payment information from the payment gateway. The data collected from the payment gateway may be used to collect matching data related to the order from the ecommerce platform. The files may be transmitted to a chargeback database and program where an automated process creates a response containing the data required to investigate and challenge the chargeback notification and transmits that data back to the payment processor.

Additional advantages and features of the invention will be set forth in part in the description which follows, and in part will become apparent to those skilled in the art upon examination of the following or may be learned by practice of the invention.

### BRIEF DESCRIPTION OF THE DRAWINGS

FIG. 1 illustrates a contextual view of an exemplary computing environment for a chargeback dispute processing system and method.

FIG. 2 illustrates the overall process of a chargeback disputer system and method.

FIG. 3 is a screen shot of a services interface.

FIG. 4 is a screen shot of the home page of an exemplary administrative interface (front end application).

FIG. 5 is a screen shot of an exemplary screen for creating individual paragraphs for chargeback letters.

FIG. 6 is a screen shot illustrating functionality used to create letter parts.

FIG. 7 illustrates a screen provided to allow a user to view the details of individual letters.

FIG. 8 is an exemplary screen for creating reason codes.

FIG. 9 illustrates a screen for maintaining passwords to chargeback disputer programs.

FIG. 10 is a screen shot of an exemplary chargeback letter creator system screen for mapping variables to data source files.

FIG. 11 is a screen shot of a menu screen displaying process details for a chargeback integration.

FIG. 12 is a screen shot of job details.

FIG. 13 is a screen shot of a system screen allowing a user to view order details for each processed chargeback/order.

FIG. 14 is a screen shot of a system screen which allows the user to view statistics on program processing.

FIG. 15 is an exemplary configuration screen which allows a user to configure new data source files.

FIG. 16 is an exemplary configuration screen which allows a user to specify whether email content is required in a data source file.

### DETAILED DESCRIPTION

Listed below are a few of the commonly used terms for the preferred embodiment of the Infrastructure-as-a-service system and method.

### Common Terms and Acronyms

case control: a unique identifier provided by the payment processor for each chargeback requested by a payment processor

Centralized Payment Gateway (CPG): a payment platform integrated with an ecommerce purchase order system and a plurality of payment processors and processing payment-related transactions for orders placed on the ecommerce system.

ecommerce platform: the combined hardware and software environment for an ecommerce system. The commerce platform includes, hosts and supports a suite of functionality for selling and purchasing products on the internet, for example but not limited to, secure shopping carts, product catalogs and which may include integrations with at least one payment gateway. In this document, the terms commerce and e-commerce are synonymous.

payment method: type of payment chosen by the customer for a transaction (e.g. VISA, Mastercard, American Express, etc).

payment processor: the external payment service provider processing the payment transaction. Each payment method is associated with one or more payment service providers.

Request for information (RFI): a name given to the chargeback notification supplied by the payment processor/payment service provider.

The terminology used in the description below is intended to be interpreted in its broadest reasonable manner, even though it is being used in conjunction with a detailed description of certain specific embodiments. Certain terms may even be emphasized below; however, any terminology intended to be interpreted in any restricted manner will be overtly and specifically defined as such in this Detailed Description section.

The sections below describe particular embodiments of a chargeback disputer system and method. One skilled in the art will understand, however, that the invention may be practiced without many of these details. Additionally, some well-known structures or functions may not be shown or described in detail, so as to avoid unnecessarily obscuring the relevant description of the various embodiments.

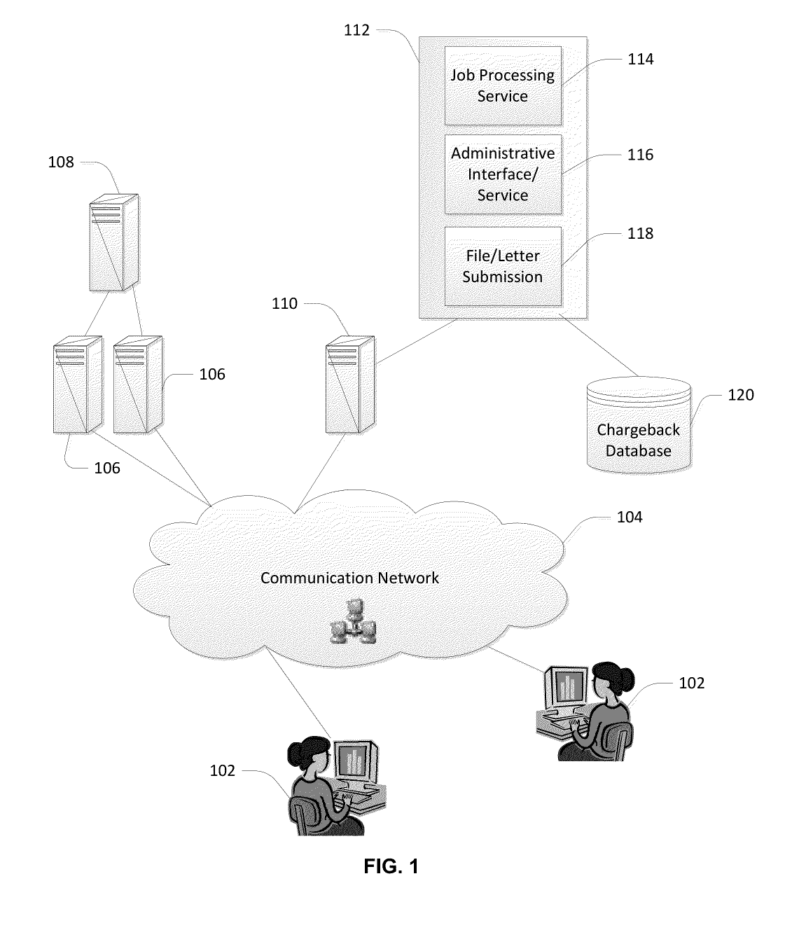

FIG. 1 and the following discussion provide a brief, contextual view and general description of a suitable computing environment in which the claimed system and method can be implemented. Although not required, aspects of the system and method are described in the general context of computer-executable instructions, such as routines executed by a general purpose computer, e.g. a server computer, wireless device or personal computer. Those skilled in the relevant art will appreciate that the invention can be practiced with other communications, data processing, or computer system configurations as well as those discussed.

Referring then to FIG. 1, “end users” (aka customers or consumers) 102 purchase products over the internet 104 from an ecommerce provider 106. When the end user completes a purchase transaction using a payment service, such as Paypal, or a credit card, the payment is processed through a payment gateway 108 with access to the various payment processors or transaction clearinghouse services 110. If a customer subsequently files a chargeback request to the issuing bank or service, the payment processor 110 sends a notice to the transacting system 108 to reverse the charge. This chargeback request includes reason codes for the request. A chargeback disputer system, comprises a services server 112 with modules 114, 116 resident in computer memory and comprised of computer-executable instructions, which when executed by the server processor cause the server to perform the functions described herein, including gathering of data required for evaluating the chargeback request from both the commerce system and the payment gateway. A third program, a File/Letter transport program 118, is comprised of email, file transfer and application programming interface functionality and the like, and is used to submit the gathered information or file to the issuing bank. While these functions are illustrated in FIG. 1 as being performed on separate servers, one of ordinary skill in the art would understand that the functions may be located on one or many servers and may be distributed in many different ways without deterring from the spirit and scope of the claimed system and method.

This exemplary system includes various computers, computing devices or electronic devices, including, for example, end user machines (e.g. personal computer, workstation, etc.) 102, a communication network 104 and one or more servers 106, 108 hosting web sites, applications and web services. The computer, computing or electronic device (and server as a type of computing device) typically includes a memory, a secondary storage device, a processor (central processing unit, or CPU), an input device, a display device, and an output device. The memory may include random access memory (RAM) or similar types of memory. Software modules and applications, stored in the memory or secondary storage for execution by a processor are operatively configured to perform the operations of the exemplary system. The software applications may correspond with a single module or any number of modules. Modules are program code or instructions for controlling a computer processor to perform a particular method to implement the features or operations of the system. The modules may also be implemented using program products or a combination of software and specialized hardware components. In addition, the modules may be executed on multiple processors for processing a large number of transactions, if necessary or desired.

The secondary storage device may include a hard disk drive, floppy disk drive, CD-ROM drive, DVD-ROM drive, or other types of non-volatile data storage, and may correspond with the various equipment and modules shown in the figures. The processor may execute the software applications or programs either stored in memory or secondary storage or received from the Internet or other network. The input device may include any device for entering information into computer, such as a keyboard, joy-stick, cursor-control device, or touch-screen. The display device may include any type of device for presenting visual information such as, for example, a computer monitor or flat-screen display. The output device may include any type of device for presenting a hard copy of information, such as a printer, and other types of output devices include speakers or any device for providing information in audio form.

Although the computer or computing device has been described with various components, one skilled in the art will appreciate that such a computer or computing device can contain additional or different components and configurations. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. One skilled in the art would recognize that computing devices may be client or server computers. Client computers and devices (e.g. 102) are those used by end users to access information from a server over a network, such as the Internet 104. Servers are understood to be those computing devices 106, 108, 112 that provide services to other machines, and may be (but are not required to be) dedicated to hosting applications or content to be accessed by any number of client computers. Web servers, application servers and data storage servers may be hosted on the same or different machines 106, 108, 112.

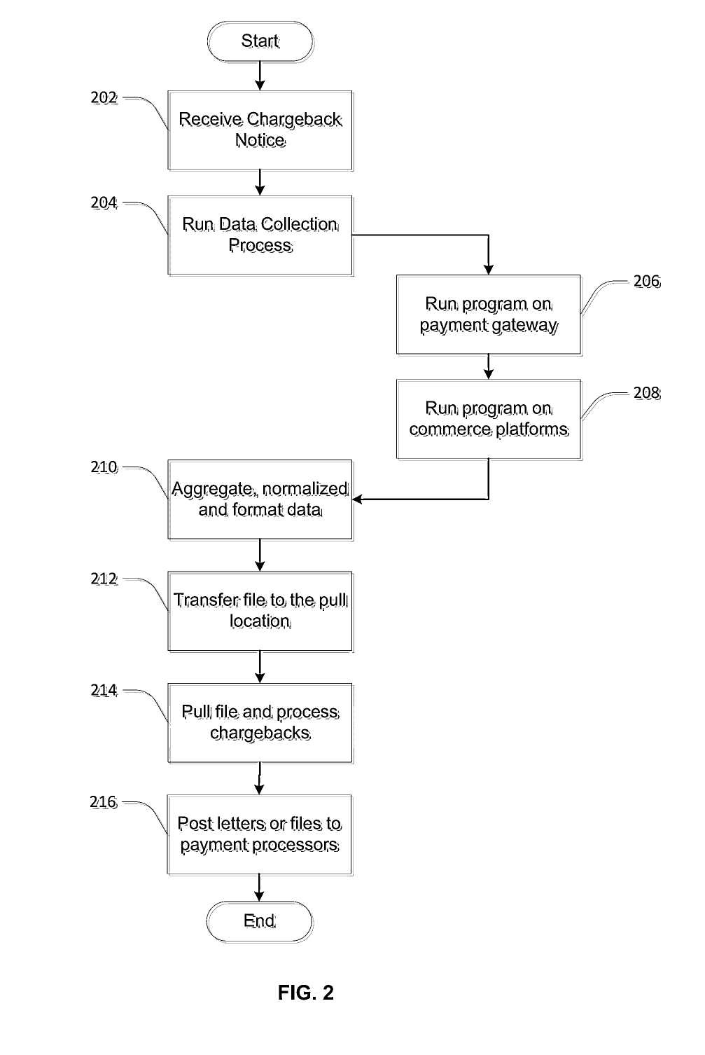

FIG. 2 illustrates the overall process of a chargeback dispute. When a customer disputes a charge to a credit card, bank or payment processor (collectively known as “issuing banks”), the issuing bank notifies the transacting merchant 202 with either a request for information about the underlying charge or a chargeback request. A chargeback is the return of funds to a customer. More specifically, it is the reversal of a prior outbound transfer of funds from a customer's bank account, line of credit, or credit card. With each chargeback the issuer selects and submits a numeric reason code. This feedback helps the merchant (and acquirer) diagnose errors and improve customer satisfaction. Reason codes vary by bank network, but fall in four general categories:
Technical: Expired authorization, non-sufficient funds, or bank processing error.
Clerical: Duplicate billing, incorrect amount billed, or refund never issued.
Quality: Consumer claims to have never received the goods as promised at the time of purchase.
Fraud: Consumer claims they did not authorize the purchase, or identity theft.

One of the most common reasons for a chargeback is a fraudulent transaction, or the claim that a credit card is used without the consent or proper authorization of the card holder. In some cases, a merchant is responsible for charges fraudulently imposed on a customer. Mostly, fraudulent card transactions originate with criminals who gain access to secure payment card data and set up schemes to exploit those data. Chargebacks can also result from a customer dispute over credit. This type of chargeback is usually described as credit not processed. A customer may have returned merchandise to a merchant in return for credit, but credit was never posted to the account. In this example, the merchant is responsible for issuing credit to its customer, and would be charged back. Other types of chargebacks are related to technical problems between the merchant and the issuing bank, whereby a customer was charged twice for a single transaction (duplicate processing) or other various mistakes. Yet other chargebacks are related to the authorization process of a credit card transaction, for example, if a transaction is declined by its issuing bank and the account is still charged. Another reason for chargebacks is when a customer does not receive the item they paid for. In this case, a chargeback is initiated and the payment to the merchant is reversed.

In the case of an integrated e-commerce system, the payment transaction generally, but not always, takes place on a centralized payment gateway 108 which brokers the relationships between the selling merchants 106 and the payment processors 110. At regular intervals, after receiving notification, the chargeback disputer program runs 204 and collects data from the payment gateway 206 related to the Requests for Information (RFI) and chargebacks received previously. Once the order data has been gathered from the payment platform, additional order and shipping related data is obtained from the e-commerce platform 208. The data from the various platforms is aggregated, normalized and formatted 210 into a tab delimited file which is then transferred to an assigned location 212. Again at regular intervals, the file is picked up from the transfer location and processed 214, resulting in persistent database records and a letter or file for each payment processor 216.

### Data Aggregation and Preparation

The enhanced chargeback re-presentment process may use a script, such as a PERL script, that utilizes SQL queries hitting various platforms, collecting the data needed to investigate chargebacks. As was described above, the program first gathers data from the payment platform 108 regarding the RFIs and chargebacks that were received the previous day. Table 1 presents the type of data that would be useful for this purpose, including an exemplary table/field identification.

TABLE 1
Chargeback data from the payment platform

| Data Point | Exemplary Data Source |
|---|---|
| Order ID | cpg_payment_transaction.DIVISION_ORDER_ID |
| CPG Auth ID | cpg_payment_transaction.TRANSACTION_ID - on Auth Transaction |
| Processor | cpg_payment_transaction.PAYMENT_SERVICE_ID |
| Chargeback Code | cpg_payment_transaction.RESPONSE_CODE_1 |
| Transaction Type | cpg_payment_transaction.TRANSACTION_TYPE |
| Transaction Reference Number | cpg_payment_transaction.CUSTOM_DATA |
| Order Date | cpg_payment_transaction.ORDER_DATE |
| Platform | cpg_payment_transaction.DIVISION_ID |
| Billing First Name | cpg_payment_transaction.FIRST_NAME |
| Billing Last Name | cpg_payment_transaction.LAST_NAME |
| Billing Address 1 | cpg_payment_transaction.BILLING_ADDRESS_LINE_1 |
| Billing Address 2 | cpg_payment_transaction.BILLING_ADDRESS_LINE_2 |
| Billing City | cpg_payment_transaction.BILLING_ADDRESS_CITY |
| Billing State | cpg_payment_transaction.BILLING_ADDRESS_STATE |
| Billing Zip | cpg_payment_transaction.BILLING_ADDRESS_POSTAL_CODE |
| Billing Country | cpg_payment_transaction.BILLING_ADDRESS_COUNTRY_ID |
| Billing Email | cpg_payment_transaction.BILLING_ADDRESS_EMAIL_ADDRESS |
| IP Address | cpg_payment_transaction.CUSTOMER_IP - on Auth Transaction |
| Credit Card last 5/Billing Acct | Cpg_payment_transaction.LAST5 |
| Descriptor | cpg_payment_transaction.MERCHANT_DESCRIPTOR |
| AVS Results | cpg_payment_transaction.RESPONSE_CODE_2 - on AuthTrx |
| Site ID | cpg_payment_transaction.DIVISION_SITE_ID |

Table 2 presents exemplary data collected from an e-commerce platform, which is extracted by matching on appropriate fields, such as platform and order ID.

TABLE 2
E-commerce platform data

| Data Point | Platform Location |
|---|---|
| Shipping First Name | ec_shipto.FIRST_NAME |
| Shipping Last Name | ec_shipto.LAST_NAME |
| Shipping Address 1 | ec_shipto.ADDRESS1 |
| Shipping Address 2 | ec_shipto.ADDRESS2 |
| Shipping City | ec_shipto.CITY |
| Shipping State | ec_shipto.STATE |
| Shipping Zip | ec_shipto.ZIP_CODE |
| Shipping Country | ec_shipto.COUNTY_NAME |
| Shipping Email | ec_shipto.EMAIL_ADDRESS |
| Product Name | |
| Product Description | |
| Password | |
| Order Amount | ec_orders.ORDER_AMOUNT |
| Order Date | ec_orders.ORDER_DATE |
| Site Owner | |
| IP used to download software | ec_download_log.IP_ADDRESS |
| File Name | ec_download_requests.FILE_NAME |
| Bytes Requested | ec_download_log.FILE_SIZE |
| Bytes Received | ec_download_log.BYTES_ |
| | TRANSFERRED |
| Timestamp of software download | ec_download_log.START_TIME |
| Shipper | |
| Shipment Tracking Number | |
| Shipping Date | |
| Notifications - Date | |
| Notifications - Type | |
| Notifications - Email | |
| CS Log - Contact info with dates | |
| of contacts | |

In creating the file, generally, if an order has multiple line items a new record may be created for each line item. If a platform does not contain all data points the field may be left blank. Once all data extraction from the various platforms have been completed, a script, such as a PERL script, creates a file (e.g. tab or comma delimited) by aggregating and normalizing the data. This file is posted to a location for processing by a chargeback disputer program 112.

### Chargeback Disputer Program

A chargeback disputer program 112 (also referred to as a chargeback letter creator in the described preferred embodiment) takes the order chargeback file and uses it to create a letter or file to submit to payment providers. Alternatively, integrations with any particular payment provider may allow disputes to be processed through an API. An order chargeback file, letter or message may also contain information from the chargeback request itself, such as the reason code. If the information needed to create the letter, file or message is not available in the spreadsheet then the program may do screen scrapes directly from the platform.

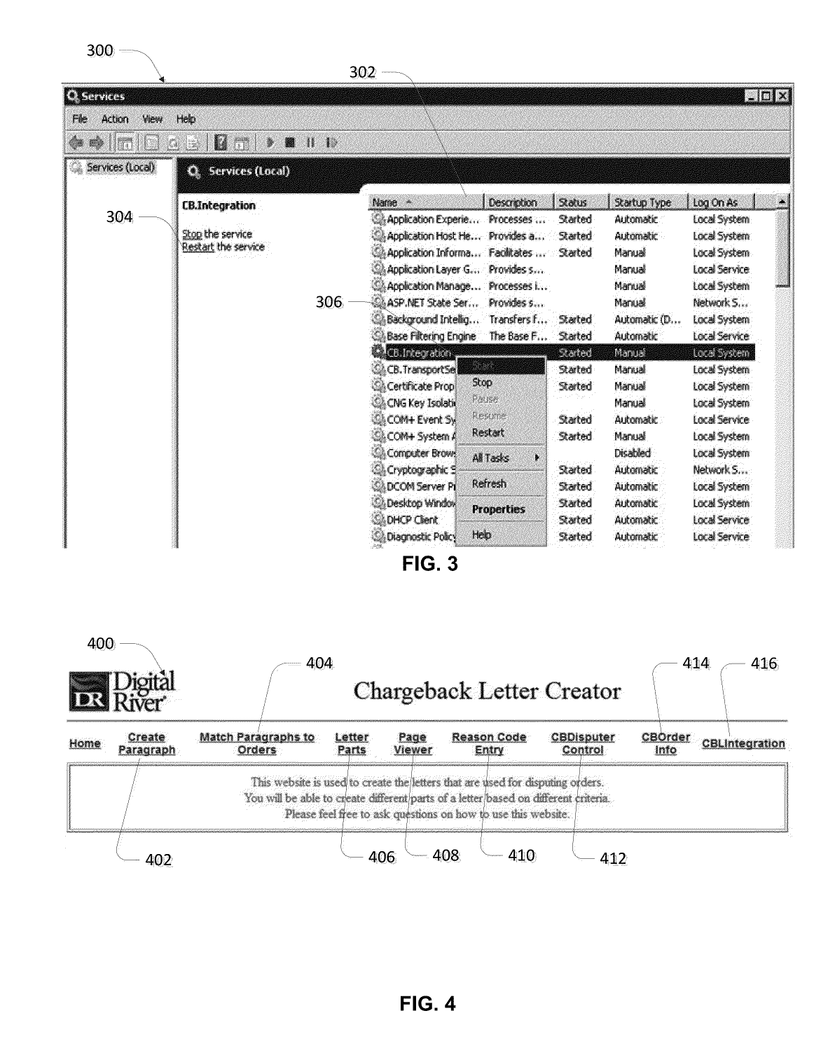

The chargeback application has two primary modules: a job processing service module and an administrative interface. The job processing module is a service that processes the chargebacks. The administrative interface is used to monitor and reprocess chargebacks. Both the job processing module and the administrative interface are configured through a configuration file in their specific folders in a job processing application. An exemplary job processing application is Windows Services 300, illustrated in FIG. 3, which is offered by way of example and not limitation. In such an application, users may view program job details 302 such as a description, the status of the program and the startup type. Users may stop and restart services 304 from this page as well. Those skilled in the art will recognize that the features described herein may be run by any type of operating system job processing application.

The chargeback service may be installed on a machine accessible to others and identified by machine name, domain and IP address. An exemplary chargeback service application is comprised of two primary services: transport service and chargeback processing service.

### Transport Service

When started, this service runs at regular configured intervals and is responsible for transferring files from a file location, such as an ftp folder, to the application for subsequent processing. Once the files are transferred they are deleted from the original file location and a job is created for processing each file. The file is renamed using a convention, such as jobid_Filename. The service can be configured with filters so only files of specific naming convention are picked up for processing. If the service is stopped no new file will be retrieved for processing. The service may be scheduled to run at regular intervals, such as every hour.

A database table contains the end point and credential details of the transport from which files will be pulled down for processing. An exemplary query on a database table called core_transport is presented in Table 3, below. Locations having the field “inbound” as true (1) indicate that they are inbound locations for file processing.

TABLE 3
Database Table Query: core_transport

```
SELECT [transport_id]
  ,[transport_type]
  ,[description]
  ,[end_point]
  ,[timeout]
  ,[retry_count]
  ,[creation_date]
  ,[modification_date]
  ,[client_id]
  ,[user_name]
  ,[user_password]
  ,[port]
  ,[inbound]
FROM [Chargeback_DB].[dbo].[core_transport]
```

Table 4 contains configuration details for pulling a file from the original file location.

TABLE 4
Configuration details

| Type | Details |
|---|---|
| Transport type | <Transport default=″FTP″> |
| | <Plugin mode=″FTP″ |
| | type=″CB.Core.Implementation.Transport.FtpTransport, CB.Core″ /> |
| | </Transport> |
| Scheduling | <TransportService><![CDATA[0 0/55 * * * ?]]></TransportService> |
| File Filter | <FileMatcher usedatefilter=″false″> |
| | <FileName><![CDATA[ [symbol] C[\w- |
| | .!#$%&′*+/= [symbol] _′{\|}~]*]]></FileName> |
| | <FileExtension><![CDATA[\.(csv\|xls)$]]></FileExtension> |
| | <FileType>1</FileType> |
| | <DateFormat>MMddyyyy</DateFormat> |
| | </FileMatcher> |

Again referring to FIG. 3 the illustrated the process in a Windows operating system environment shows a screen shot of a services interface accessed through the control panel→Administrative Tools→Services. Users may start and stop the service by right clicking on the file name (in this case, CB.Transport.Service) 306.

Files transferred to or from an FTP location may be copied over to the configured job folder and renamed by adding the job id as a suffix to the filename. Example file folders include:
Property: ftpRootDir
Description: The root directory which would contain other ftp folders
Production Location: C:\Chargeback\ftp
Property: localDestinationDir
Description: The directory within the ftp root directory which will be used as a temporary destination to store files transferred from the FTP folder.
Production Location: C:\Chargeback\ftp\Download

### Integration Health Monitor Service

This service accommodates issues with lack of response or slow processing that may occur while files are processing. These issues typically resolve themselves when the system is restarted. An Integration Health Monitor Service was implemented in order to remove manual intervention needed to stop and restart the service by performing those tasks automatically. Whenever it detects that the system is getting slower and/or not processing files properly it will refresh the integration service. The service sends email notifications whenever the CBIntegration service is restarted. This service may be scheduled to run at designated intervals, such as every two hours.

### Chargeback Job Processing Service

This service when started runs at regular configured intervals to process the files transferred by the transport service. All the chargebacks within the file are processed and the results are persisted in the database. A status mail is also sent after the processing of each job. If the service is stopped while a file is in process, it is flagged for reprocessing.

To start or stop the service, a user may right click on the CB.TransportService and clicks on Start to start or Stop to stop the service. One skilled in the relevant arts would understand that there could be jobs processing at any point in time so it is advisable to check if there are any jobs in Processing state before Stopping the service. Additionally, when the service is started, the application will re-process any jobs stuck in processing state due to shutdown of the service.

The job processing service may be configured to run once a day. At the start of the service the job will change the state of all jobs in ‘PROCESSING’ state to ‘OPEN’ state. This to avoid jobs stuck in ‘PROCESSING’ state if the service terminated abruptly.

All jobs in ‘OPEN’ state will then be queued for processing synchronously. Case controls within the file will be processed in batches as per the payment processor. Each order is processed individually within the batch.

The service may be named CB.Integration and scheduled at regular intervals, such as once per day. In an exemplary embodiment, the database may have one record per file, typically in a table identifying chargeback jobs and named appropriately, such as tbl_job. The status will indicate the status of the job.

TABLE 5
Database Table Query: tbl_Job

```
SELECT [Job_Id]
  ,[FileName]
  ,[Status]
  ,[WorkingFileName]
  ,[WorkFlowType]
  ,[processfiletype]
  ,[CreatedDate]
  ,[ModifiedDate]
FROM [Chargeback_DB].[dbo].[tbl_Job]
```

TABLE 6
Job Status

| Name | Description |
|---|---|
| OPEN | Initial State of the Job |
| PROCESSING | After the service has picked up the job and started |
| | processing the case control |
| COMPLETED | After all the case controls have been processed |
| RETRY | Initial state of the job created to retry case controls |
| FAILED | Failure state of the job, likely cause could be format of |
| | the file is wrong or the database was not reachable. |

The functionality for the monitoring and retrying chargeback files may be contained under the CBIntegration menu of the associated Chargeback Letter Creator application, described below. Please refer to relevant sections below for details of each screen.

A job messages table may be used for monitoring or debugging the processing of a job. During the processing of a job, messages may be added to the JobMessages table to record the progress of a job.

TABLE 7
Database Table: JobMessages

```
SELECT [message_id]
  ,[job_id]
  ,[case_control_id]
  ,[order_id]
  ,[received_on]
  ,[msg_text]
FROM [Chargeback_DB].[dbo].[JobMessages]
Where job_id = ′Job ID′
```

TABLE 8
Configuration Details

| Type | Details |
|---|---|
| Scheduling | <IntegrationService><![CDATA[0 0/02 * * * |
| | ?]]></IntegrationService> |

Files in production are created in the folders based on the configuration parameters in the config file.
Property: jobRootDir
Description: The root directory which would contain other job folders
Production Location: C:\Chargeback\job\
Property: jobWorkingDir
Description: Files that are currently being processed or that have been queued to be processed are stored here.
Production Location: C:\Chargeback\job\Working
Property: jobArchiveDir
Description: Files that have finished processing successfully are stored here.
Production Location: C:\Chargeback\job\Archive

### Configuration Files

There may be two configuration files that control the behavior of the chargeback application, CB.Integration and CBConfig. Exemplary sub-modules for these files are listed in Table 9, below.

TABLE 9
Configuration files and sub-modules

| Configuration File and | |
|---|---|
| Description | Sub-Modules |
| CB.Integration This file | Appsettings: this section contains settings for the |
| contains properties that | job folder locations as well as the printer and the |
| are generic. | mailing lists. |
| | Log4net: this section configures the location and |
| | customizes the logging of the application. |
| CBConfig: This config | PaymentProcessors |
| file allows customization | This section allows the configuration of the class |
| of the various modules | to use while submitting information to the |
| of the system. | specific payment processors. The URL's of the |
| | payment processor can be updated from here. |
| | CommercePlatform: |
| | Customization of the URL for the various |
| | commerce platforms are done in this section. |
| | The class responsible for handling the commerce |
| | platform is also specified from here. |
| | LetterCreater |
| | The default letter creator and the URLS for |
| | the letter creator are configured in this section. |
| | Specific letter creators such as first data are also |
| | configured in this section. |
| | PaymentLetterCreater |
| | The mapping of the letter creator handler/class |
| | to the payment processor name is configured in |
| | this section. |
| | CommerceLetterCreater |
| | The mapping of the letter creator for each |
| | specific platform to it's handler/class is |
| | configured in this section. |
| | PluginManager |
| | The plugins that are to be initialized per payment |
| | processor are configured in this section. |
| | LinkCardType |
| | The mapping between the card type represented |
| | in the input and that available in the letter creator |
| | website is configured in this section. |
| | PaymentTypes |
| | The supported payment processor and the |
| | mapping to the available values in the letter |
| | creator website is configured in this section. |
| | Workflows |
| | The supported workflow for each payment |
| | processor is configured in this section. |
| | URLSection |
| | The generic URLS of the letter creator website |
| | used during creation of the letter is configured in |
| | this section. |
| | Schedule |
| | Schedulers for both the transport as well as the |
| | chargeback processing service can be configured |
| | in this section. |
| | FileMatchers |
| | Filematchers allows filtering of the files which |
| | are retrieved from the ftp folder. |

Table 10 provides examples of Application configuration sections.

TABLE 10
Application Configuration Sections

| Name | Description |
|---|---|
| jobRootDir | The root directory of all jobs |
| jobWorkingDir | Name of the working directory of the jobs. If the |
| | job is in open or processing or Failed state the file |
| | should be in this folder. |
| jobArchiveDir | Name of the archive directory of the job. If the job |
| | is in Completed state the file should be in this |
| | directory. |
| localDestinationDir | Files from the FTP folder will be temporarily |
| | copied to this folder |
| CBConnectionString | Connection string to the database |
| CBlntegrationConfig | Name of the configuration file |
| log4net | Sections pertaining to configuration of the logging |
| | system |

### Administrative Interface

The administrative interface or front-end application is used to configure, monitor and retry failed source files and chargebacks and create the letter, file or message to be transmitted to the payment processor. The state of the chargeback could also be changed to manual if the chargeback is not to be retried in the event it fails on its initial try. Users are provided with the URL for the home page of the front end application, which in a preferred embodiment is the same as the letter creator website illustrated in FIG. 4 (chargeback letter creator). The web application may need to be started from the IIS server for it to be accessible. A folder location is provided for the letter creator.

An exemplary administrative user interface 400, is illustrated by the screen shot in FIG. 4. A Chargeback Letter Creator user interface allows a user to manually perform the administrative and processing functions of a chargeback disputer program. For example, the user may create a paragraph 402, match paragraphs to orders 404, create letter parts 406, view individual files 408, create reason codes 410, administer CBDisputerControl functions 412, and process CBOrderinfo functions 414 and CBLintegration functions 416. Further, users may create business rules for processing chargeback letters/responses.

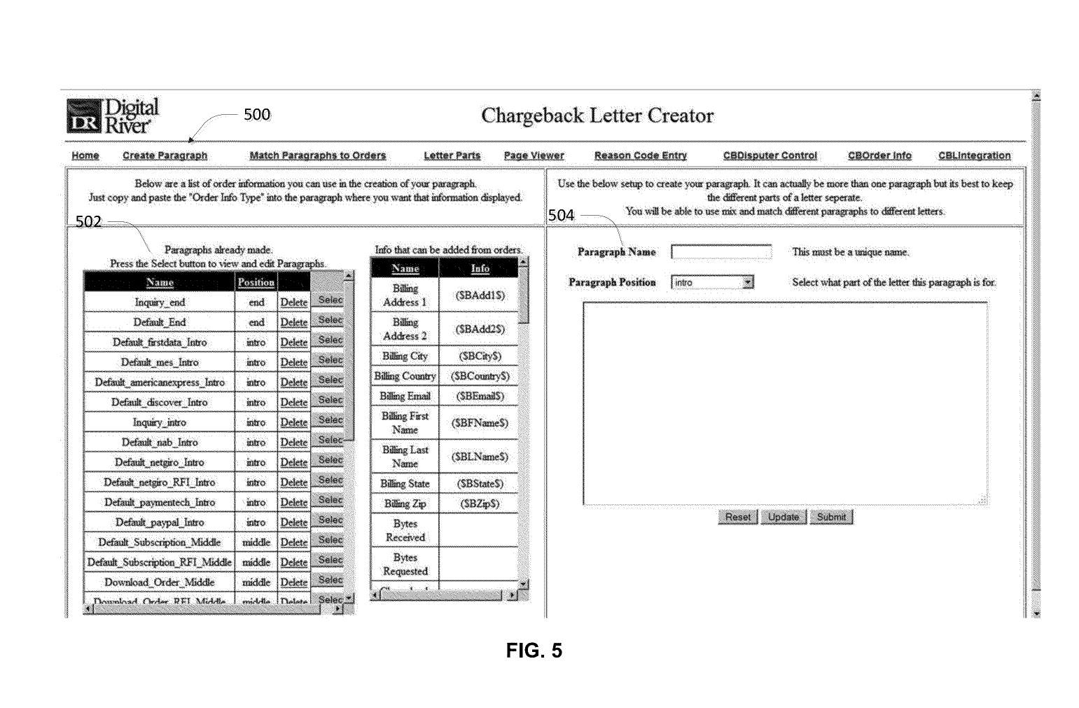

FIG. 5 is a screen shot of an exemplary screen for creating individual paragraphs for chargeback letters. This screen allows a user to create paragraphs that best fit a response to a particular reason code. The user may select and modify or delete paragraphs that have already been created 502 or create them from scratch 504.

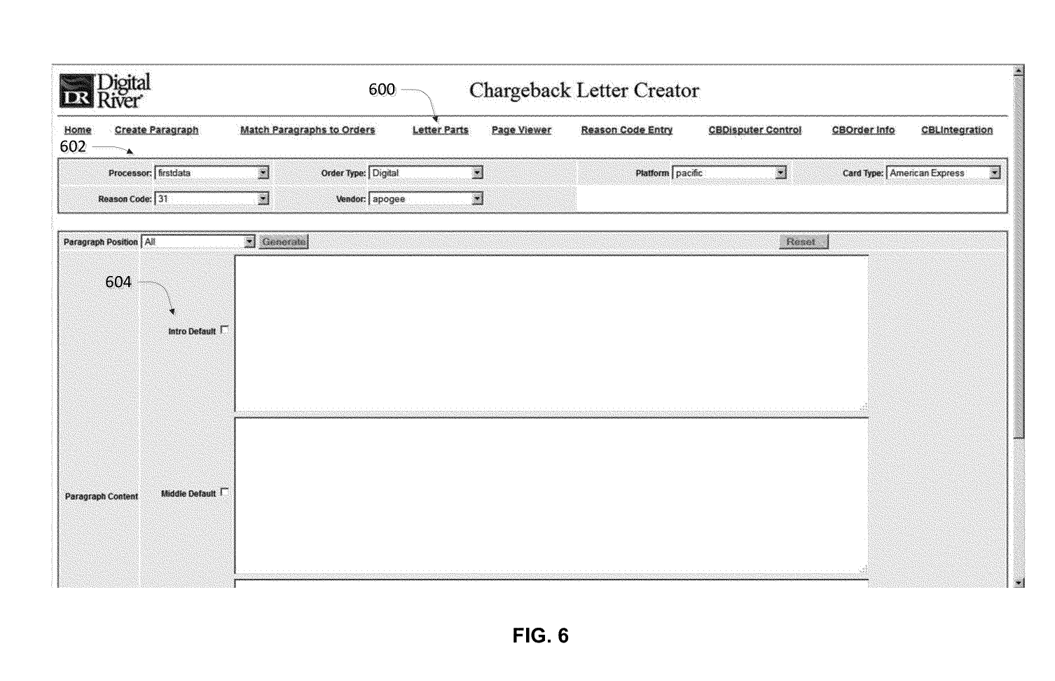

FIG. 6 is a screen shot illustrating functionality used to create letter parts 600. This screen allows a user to construct a response letter for a particular reason code, processor, order type, vendor, platform and/or card type 602. Users may select or enter default paragraphs 604 for the introduction, middle or end of the letter that are appropriate to the particular reason code. When the order has been refunded a paragraph or message field is created informing the processor of this status. This may include the amount of the refund and a demand to return the funds immediately, as well as the details of the customer refund.

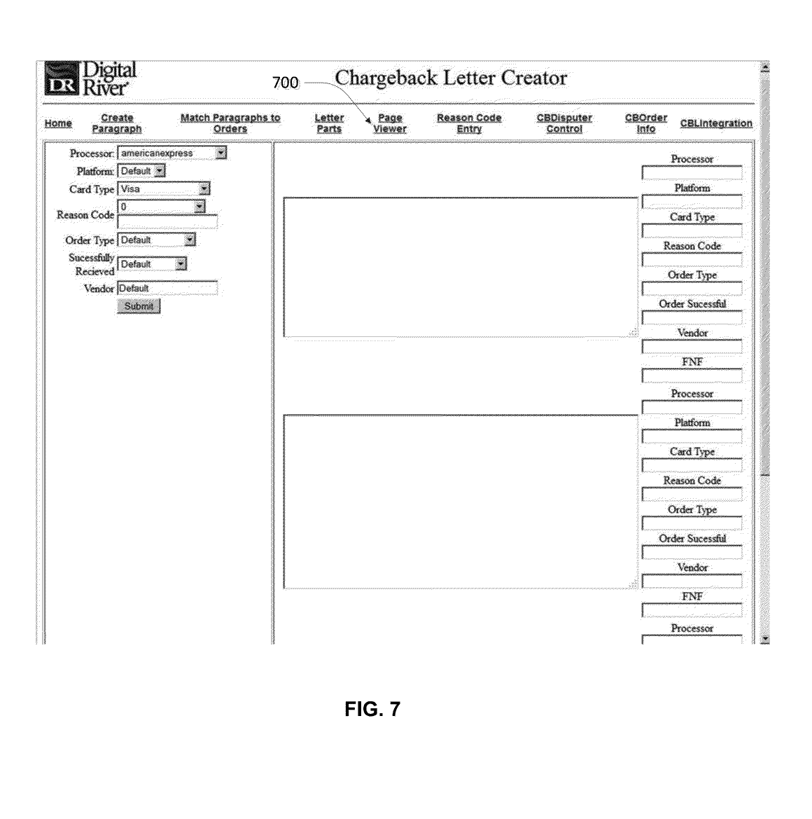

Referring to FIG. 7, a screen may be provided to allow the user to view the details of individual letters 700, make changes and resubmit the letter.

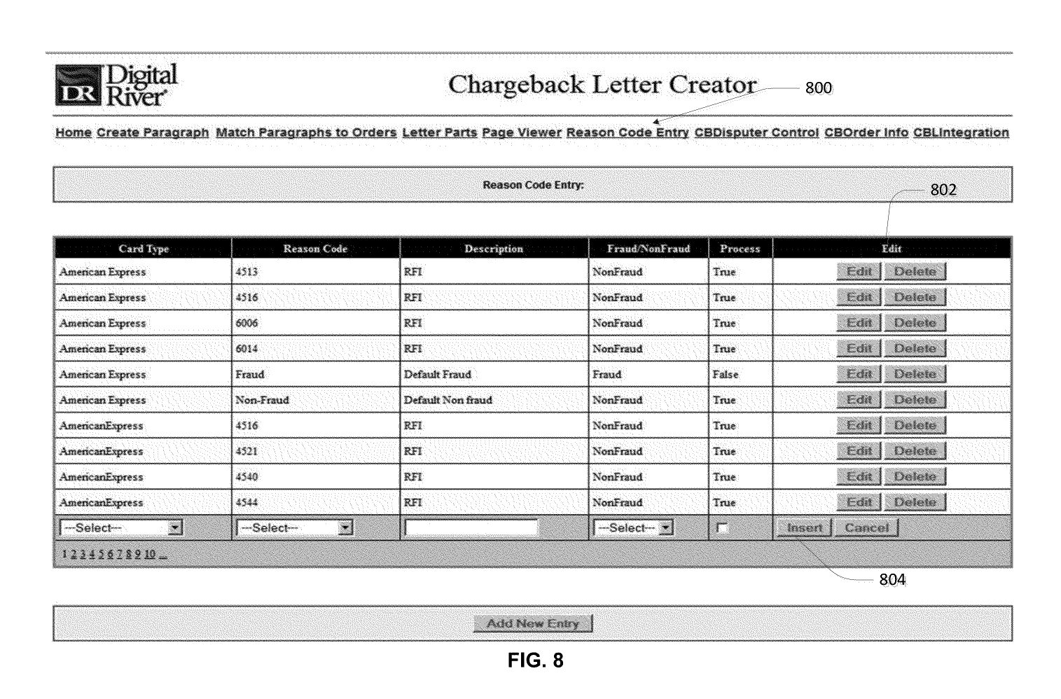

Referring to FIG. 8, a screen is provided to allow a user to edit, delete 802 or create 804 reason codes for a payment processor 800. In a preferred embodiment, reason codes drive the research, data collection and response required for a chargeback request.

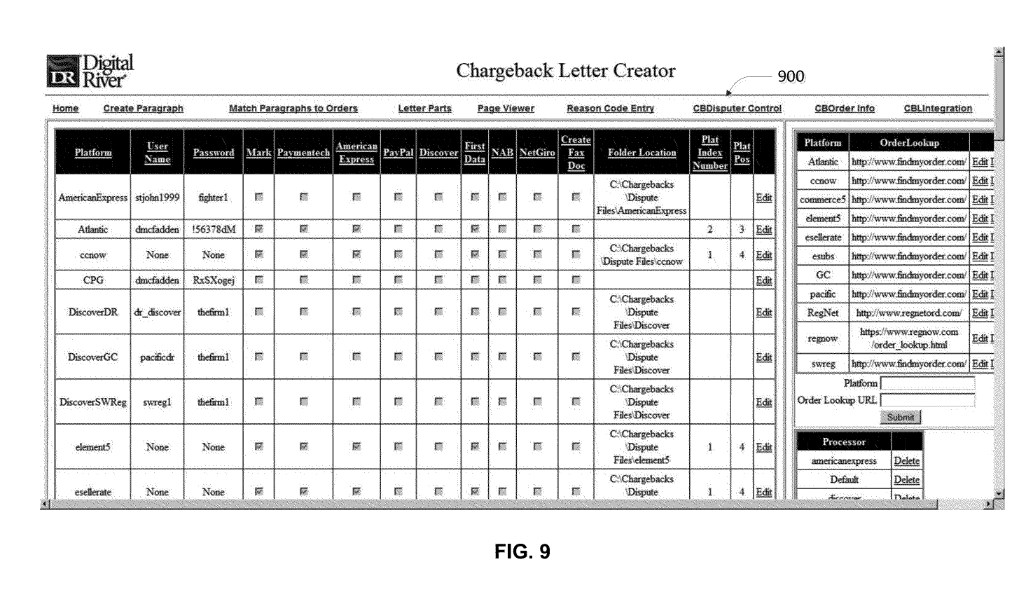

FIG. 9 is a screen shot illustrating process controls for the CBDisputerControl 900 functionality. A DisputerControl screen lists the passwords for the various user interfaces that the automated program touches. Passwords may be maintained on this screen.

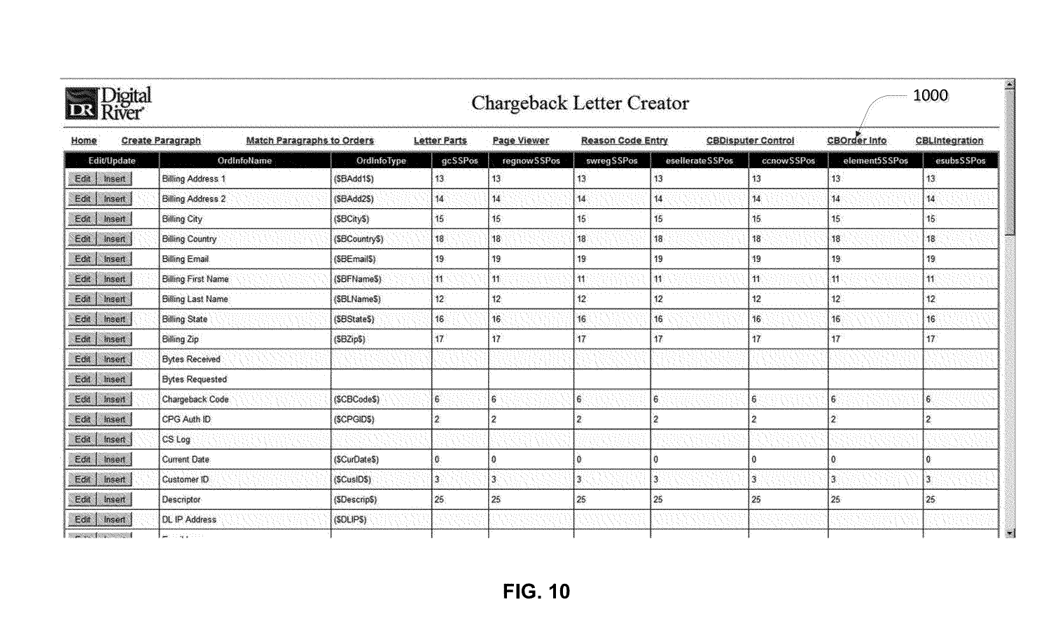

FIG. 10 is a screen shot illustrating an exemplary CBOrderinfo 1000 screen for adding, editing, or deleting order attributes to be extracted from the commerce system for a chargeback. This screen shows the mapping of the variables in the data source files. Users may edit or insert additional variables to the data collection files as needed, and view the field position of each attribute.

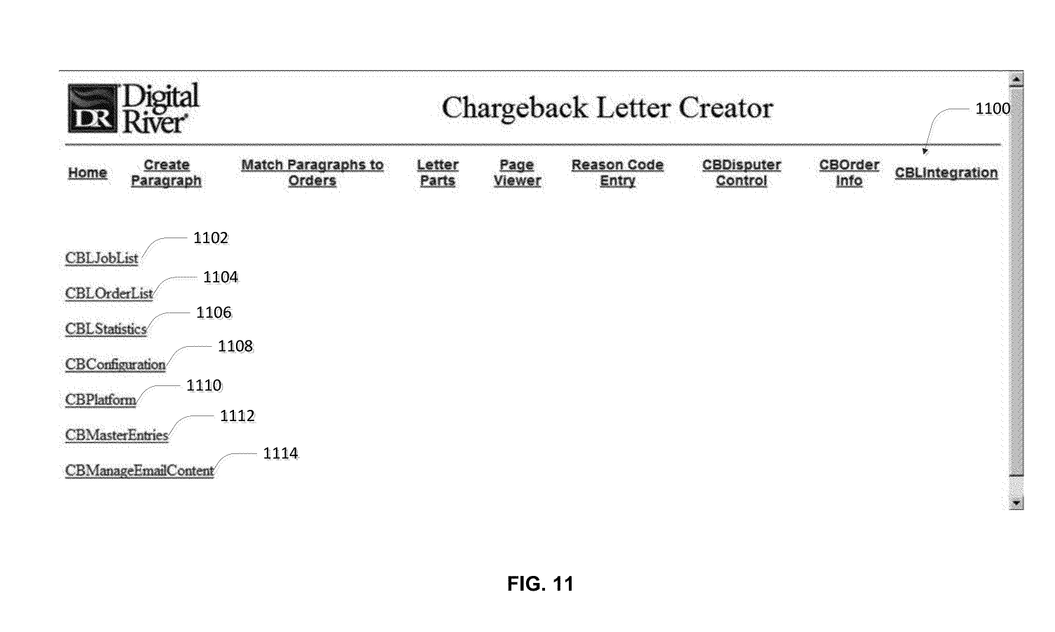

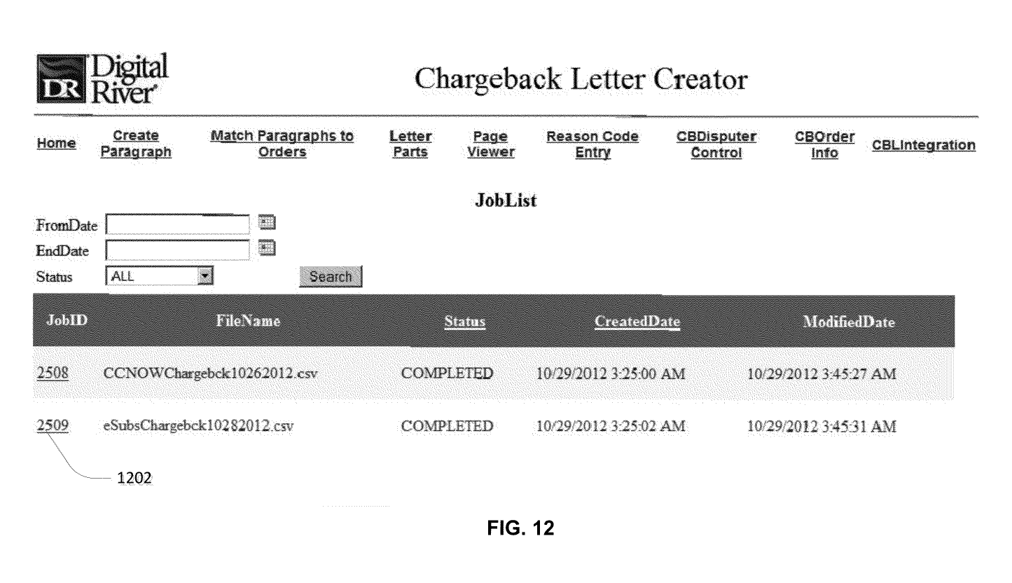

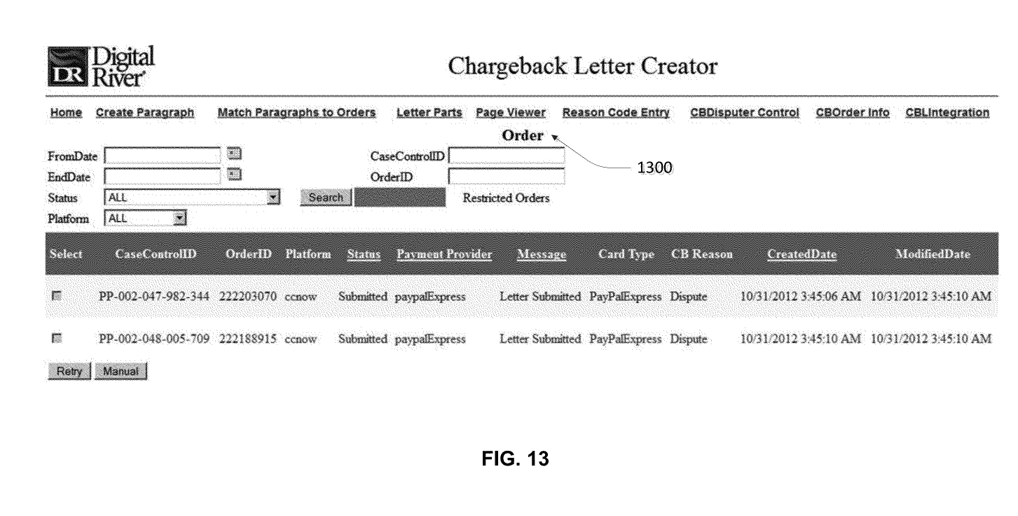

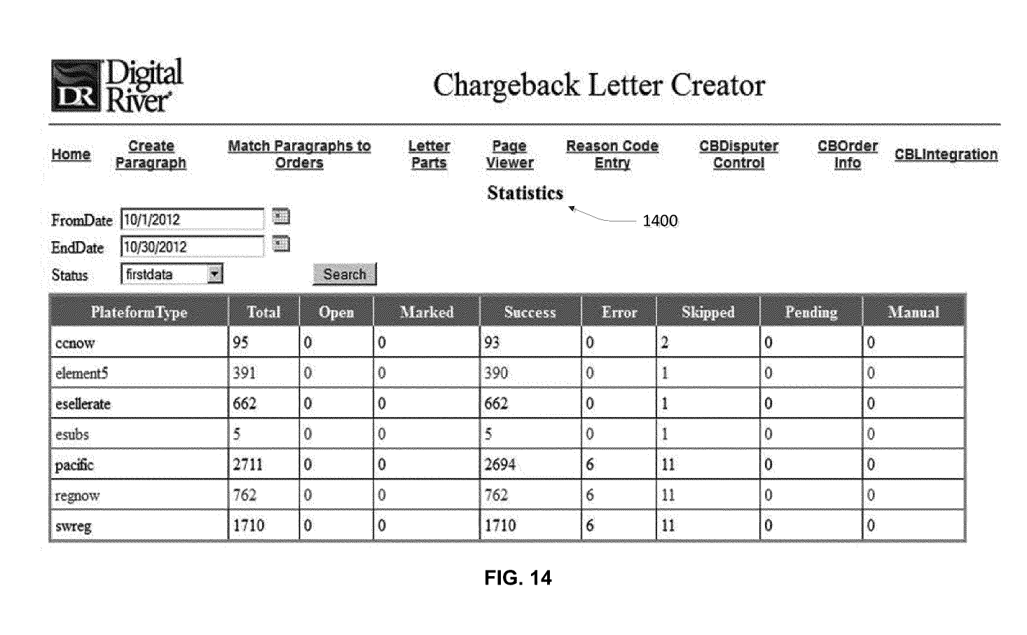

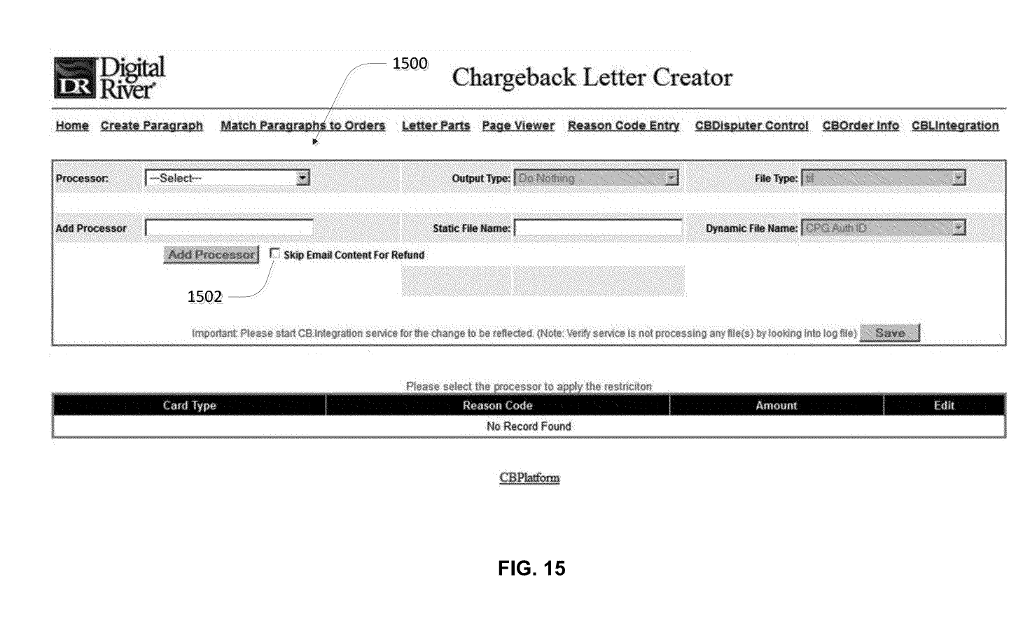

Referring to FIG. 11, the CBLintegration menu choice 1100 displays an additional process control, configuration and viewing menu, including job list 1102, order list 1104, statistics 1106, configuration 1108, platform 1110, master entries 1112 and manage email content 1114. The job list screen, FIG. 12, allows the user to search and view status for jobs by date and status. The user may click on the jobID 1202 to view the details of the job. The Orderinfo screen, FIG. 13, allows the user to view the order details 1300 for each order processed. Users may search by date, status, order platform, case control ID and order ID (see Case Control/Order Detail section below for more details on these elements). Orders may be retried, or marked for manual processing. A statistics screen (FIG. 14) allows the user to enter a date and view statistics 1400 by, for example, platform and payment processor. One of ordinary skill in the art will recognize that statistics may be viewed by selecting and searching on other variables as well. A configuration screen (FIG. 15) allows a user to configure new data source files by adding additional processors, restrictions (business rules) and platforms.

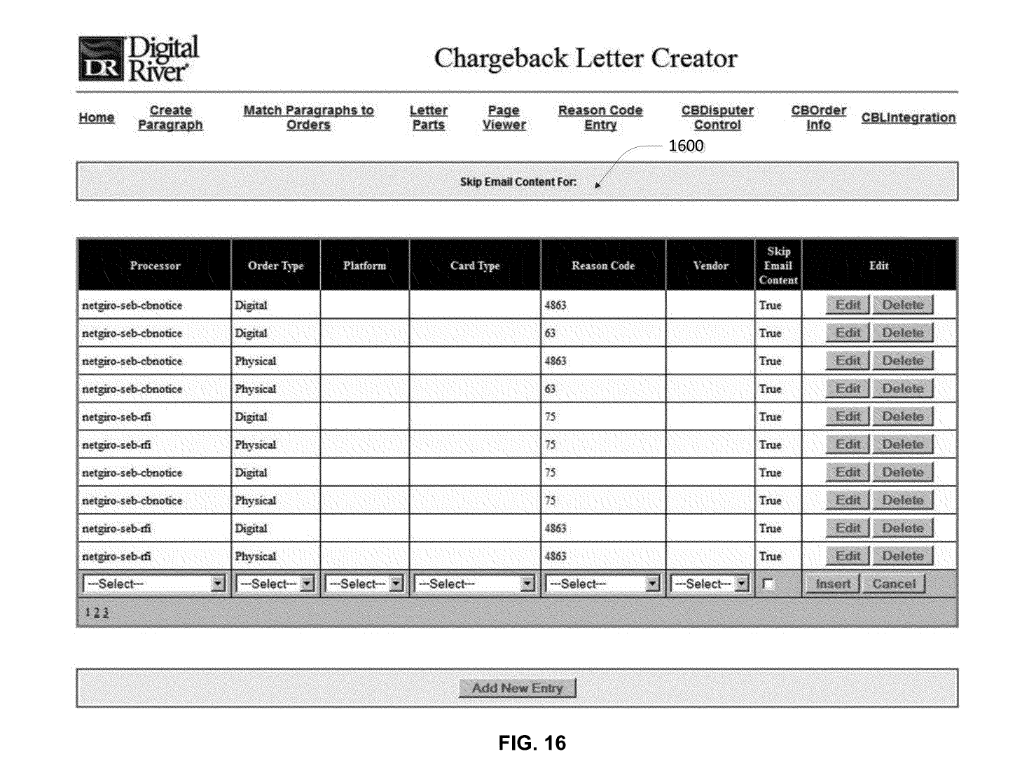

Additionally, FIG. 16 illustrates a screen provided to allow a user to specify whether email content is required 1600 for a particular processor, order type, platform, card type, reason code or vendor combination. The source file from the platform receives email content sand uses the contents in generating the letter for that particular order. Email content is pulled from the email sent to the purchaser of an item, generally thanking them for their order, summarizing the order details and describing how to download digital products, if applicable. Users may particularly wish to skip email content for a refunded order for any particular processor. This can be accomplished at the processor level by clicking the checkbox 1502 on the configuration page illustrated in FIG. 15.

### Case Control/Order Details

Each chargeback is associated with a unique chargeback identifier called as the case control number. Each case control is persisted into the database along with the order information. The case control is processed depending on the state of the case control and the workflow. Each case control may be associated with only one workflow. There could be multiple entries for a single order depending on the data sent in the input file.

A table, optimally named mdl_casecontrol_info stores the information for a case control. A combination of case control id and platform type may uniquely identify the case control.

TABLE 11
Database Table Query: tbl_ Job

```
SELECT [case_control_id]
  ,[state_id]
  ,[message]
  ,[creation_date]
  ,[modfication_date]
  ,[process_ type]
  ,[platform_type]
  ,[output_file_path]
FROM [Chargeback_DB].[dbo].[mdl_casecontrol_info]
```

The data received in the input file will be persisted in the table tbl_Order. This information will be used to regenerate the file during re-tries. If order information is already present then the information will not be persisted again.

TABLE 12
Database Table Query: tbl_Order

SELECT *
FROM [Chargeback_DB].[dbo].[tbl_Order]

Referring again to FIG. 13, case controls can be searched in the user interface through key parameters, such as the creation date, status, case control id or the order id. The page displays the list of case controls matching the search criteria. If the case controls are in an erred state the case control can be re-tried. The user selects the checkbox next to the case controls that need to be retried and select retry. The user can also change the state of the case control to manual. Once the state of the case control is changed to manual the case control cannot be retried. For case controls that cannot be retried the checkbox will be disabled.

### Case Control Processing and Workflow Details

Each case control is processed by a workflow based on the status of the current step of the workflow. There are basically three steps in a workflow process and each step can be in a failed or success state. The workflows are configured for each payment processor and the appropriate handlers will be instantiated for each supported commerce platform. Plugins allow for pre- and post-processing of case controls for a given payment processor.

TABLE 13
Database Table Query: WorkFlowContext

```
SELECT [case_control_id]
  ,[current_step]
  ,[current_state]
  ,[can_retry]
  ,[date_entered
  ,[last_updated]
FROM [Chargeback_DB].[dbo].[WorkFlowContext]
```

Table 14 is an example configuration of a workflow for FirstData having only two steps. FirstData is a payment processor.

TABLE 14
Exemplary workflow configuration - two steps

<Workflows>
<Workflow mode=″firstdata″>
<Process type=″CB.Business.Implementation.Workflow.CommercePlatformWorkflowProcess,
CB.Business″ />
<Process type=″CB.Business.Implementation.Workflow.LetterCreatorWorkflowProcess,
CB.Business″ />
</Workflow>
</Workflows>

Table 15 is an example configuration of a workflow for PaymentTech having three steps. PaymentTech is a payment processor.

TABLE 15
Exemplary workflow configuration - 3 steps

<Workflow mode=″paymentech″>
<Process type=″CB.Business.Implementation.Workflow.CommercePlatformWorkflowProcess,
CB.Business″ />
<Process type=″CB.Business.Implementation.Workflow.LetterCreatorWorkflowProcess,
CB.Business″ />
<Process type=″CB.Business.Implementation.Workflow.PaymentProcessorWorkflowProcess,
CB.Business″ /></Workflow>

Table 16 presents an example of configuration for PaymentTech and FirstData using custom plugins and Netgiro-SEB using default plugins.

TABLE 16
Exemplary workflow configuration using custom plugins

```
<PluginManager>
  <Plugin mode =″default″>
    <Process type=″CB.Business.Implementation.Plugin.DefaultPlugin, CB.Business″ />
  </Plugin>
  <Plugin mode =″firstdata″>
    <Process type=″CB.Business.Implementation.Plugin.FirstDataPlugin, CB.Business″ />
  </Plugin>
  <Plugin mode =″paymentech″>
    <Process type=″CB.Business.Implementation.Plugin.PaymentechPlugin, CB.Business″ />
  </Plugin>
  <Plugin mode =″netgiro-seb″>
    <Process type=″CB.Business.Implementation.Plugin.DefaultPlugin, CB.Business″ />
  </Plugin>
</PluginManager>
```

### Commerce Updating

Commerce platforms typically need to be updated with the results of a chargeback dispute. The script in Table 17 below is an example of the configuration of the commerce platform. The URL information of the various pages of the commerce is configurable.

TABLE 17
Commerce Platforms Section of the Configuration File

```
<!-- Commerce Platforms Section-->
  <CommercePlatform>
    <Platform name=″gc″
type=″CB.Business.Implementation.CommercePlatform.GCCommercePlatform, CB.Business″>
<ProcessLoginUrl><![CDATA[https://drhadmin-
sys.digitalriver.com/gc/ent/processLogin.do?j_username=]]></ProcessLoginUrl>
<OrderSummaryDisputeUrl><![CDATA[https://drhadmin-
sys.digitalriver.com/gc/ent/fraud/orderSummaryDispute.do?orderID=]]></OrderSummaryDisputeUrl>
<OrderSummaryUrl><![CDATA[https://drhadmin-
sys.digitalriver.com/gc/ent/customerService/orderSummary.do?orderID=]]></OrderSummaryUrl>
      <DisLogin>GC</DisLogin>
      <DigitalOrderType>Digital</DigitalOrderType>
      <PhysicalOrderType>Physical</PhysicalOrderType>
    </Platform>
</CommercePlatform>
```

### Letter/Response Creation

The format for transmitting chargeback dispute information may be flexible depending on the issuing bank's systems for processing disputes. A file, such as a delimited file, a spreadsheet, or an API message may be created from the aggregated data and transmitted to the issuing bank, for example, via FTP or API. Since chargeback investigation has historically been a manual-intensive activity, a letter with all of the order, payment and shipping information may be a convenient way to transmit the data.

Letter or file creation can be restricted to only those transactions that meet a specific criteria. FIG. 16 is a screen shot of an exemplary chargeback letter creator system web page for configuring restrictions on which chargebacks are responded to. For example, it may be desirable to respond to particular chargeback requests with a specific reason code or requests that exceed a particular threshold amount. For small transaction amounts it may not be financially feasible or desirable to dispute the chargeback request. As shown in FIG. 16, these restrictions may be configured by a payment processor, card type, reason code, or amount of the transaction. As such only chargebacks that meet a restriction criteria will be responded to in the letter creation process.

In addition, the content of the chargeback dispute information is flexible and may be changed as additional data points become available in source files. FIG. 11 is a screen shot of an exemplary chargeback letter creator system web page for editing/adding data points found in the source file. Through this user interface, the position of the additional data points (i.e., the column number in the source file), the variable name, and the data point name may be set. Once these configurations are set, the data points are available for inclusion in the chargeback dispute information as part of the letter creation process. For example, it may be desirable to include the site id, client id, merchant id, chargeback reason code, or other information in the response letter.

Letter creation is separated into basically three parts: the retrieval of information from the payment processor, the retrieval of information from the commerce platform and retrieval of configuration information from a letter creator website. An example of the information retrieved from the payment processor is listed in Table 1. An example of information retrieved from the commerce platform includes order detail as described in Table 2, and any additional data that may prove useful for investigating a chargeback request, such as the content and details of any email that was sent to the customer regarding their purchase. Information retrieved from the letter creator website includes the letter parts created for each reason code and payment processor.

Table 18 illustrates an example of configuration of a letter for FirstData and PaymentTech using custom letter creators and Netgiro-SEB using the default letter creator.

TABLE 18
Configuration of an exemplary letter

```
<PaymentLetterCreater>
<Processor name=″paymentech″
type=″CB.Business.Implementation.LetterCreator.PaymentTechLetterCreator, CB.Business″>
  </Processor>
<Processor name=″firstdata″
type=″CB.Business.Implementation.LetterCreator.FirstDataLetterCreator, CB.Business″>
  </Processor>
<Processor name=″netgiro-seb″
type=″CB.Business.Implementation.LetterCreator.DefaultLetterCreator, CB.Business″>
  </Processor>
</PaymentLetterCreater>
```

This section contains the configuration for letter creation according to platform type. The letter creator workflow process will call the appropriate class based on the platform type of the case control.

TABLE 19
Configuration for Letter Creation

<CommerceLetterCreater>
<platform name=″gc″ type=″CB.Business.Implementation.LetterCreator.GCCommerceLetterCreator,
CB.Business″/>
<Platform name=″pacific″
type=″CB.Business.Implementation.LetterCreator.GCCommerceLetterCreator, CB.Business″/>
</CommerceLetterCreater>

The location of the administrative interface (letter creator website) can be configured as below.

TABLE 20
Location of administrative interface

<Plugin mode=″cb″ type=″CB.Business.Implementation.LetterCreator.CBLetterCreator,
CB.Business″>
<LetterCreatorUrl><![CDATA[http://172.27.74.238/CB_Letter_Creator/CBLCPageViewer.aspx]]><
/LetterCreatorUrl>
<PROrderLookupUrl><![CDATA[http://dc1frauddev01.auxil.drivcomm.net/CB_Letter_Creator/Page
Requests/PROrderLookup.aspx?Platform=]]></PROrderLookupUrl>
</Plugin>

Table 21 includes script for custom configuration information for a particular issuing bank, FirstData.

TABLE 21
Sample configuration script for an issuing bank

```
    <Plugin mode =″firstdata″ type
=″CB.Business.Implementation.LetterCreator.FirstDataLetterCreator, CB.Business″>
      <HeaderRecordType>H</HeaderRecordType>
      <DetailRecordType>D</DetailRecordType>
      <TrailerRecordType>T</TrailerRecordType>
      <ResponseType>
        <Platform>
          <PlatformType type =″pacific″>
            <ResponseCode key=″Not Refunded″ value=″REBUTTAL″></ResponseCode>
            <ResponseCode key=″Refunded″ value=″CBCREDIT″></ResponseCode>
          </PlatformType>
          <PlatformType type =″gc″>
            <ResponseCode key=″Not Refunded″ value=″REBUTTAL″></ResponseCode>
            <ResponseCode key=″Refunded″ value=″CBCREDIT″></ResponseCode>
          </PlatformType>
        </Platform>
  </ResponseType>
      <DateFormat>yyyyMMdd</DateFormat>
      <TimeFormat>hhmmss</TimeFormat>
      <LocalWorkingDirectory>E:\Chargeback\job\Working</LocalWorkingDirectory>
      <ClassId>DS1DIGRV</ClassId>
      <IndexFileName>\Index.txt</IndexFileName> </Plugin>
```

Additional configuration for mapping input type to values in the letter creator website is available for configuration in the below sections.

This section is added for getting link Processor configuration for letter creator website to pass parameter as per letter creator website correct format. Table 22 provides an exemplary script for a letter creator configuration. Table 23 provides an exemplary script for getting correct login information from the database for a payment type.

TABLE 22
Mapping script for letter creator

```
<LinkCardType>
  <CardType key=″AmericanExpress″ value=″americanexpress″><
  /CardType>
  <CardType key=″discover″ value=″discover″></CardType>
  <CardType key=″nab″ value=″nab″></CardType>
  <CardType key=″netgiro″ value=″netgiro″></CardType>
  <CardType key=″paypal″ value=″paypal″></CardType>
  <CardType key=″netgiro-seb″ value=″netgiro″></CardType>
</LinkCardType>
```

TABLE 23
Script for defining payment types to obtain login info from database

```
<PaymentTypes>
  <PaymentType key=″paymentech″ value=″paymentech″><
  /PaymentType>
  <PaymentType key=″firstdata″ value=″firstdata″></PaymentType>
  <PaymentType key=″netgiro-seb″ value=″netgiro″></PaymentType>
</PaymentTypes>
```

### Payment Processor Submission

As discussed above, the format of the output data may be a file or letter, depending on the requirements of the payment processor. At present, letter submission may be supported for only a few processors, such as PaymentTech and FirstData. The script presented in Table 24 is a section of a configuration that allows for the configuration of the payment processors.

TABLE 24
Script for configuring payment processors

```
<PaymentProcessors>
<Processor name=″paymentech″
type=″CB.Business.Implementation.Payment.PaymentTechPaymentProcessor, CB.Business″>
<LoginUrl><![CDATA[https://my.paymentech.net/login/log_log_page.jsp?CTAuthMode=BASIC&ct_
orig_uri=%2FPTO%2Finitialize.jsp]]></LoginUrl>
    <InitializeUrl><![CDATA[https://my.paymentech.net/PTO/initializejsp]]></InitializeUrl>
<SearchQueryUrl><![CDATA[https://my.paymentech.net/cbiWeb/searchQuery.do?method=dispatch
&queryType=basic&caseStatusDateOp=between&dueDateOp=between&field=Advanced&sequence
NumOp==&sequenceNum=]]></SearchQueryUrl>
    <CaseUrl><![CDATA[https://my.paymentech.net/cbi/Case?op=g&id=]]></CaseUrl>
<DisplayDecisionUrl><![CDATA[https://my.paymentech.net/cbiWeb/displayDecision.do?decision=
CHALLENGE&caseID=]]></DisplayDecisionUrl>
<ProcessDecisionUrl><![DATA[https://my.paymentech.net/cbiWeb/processDecision.do]]></Process
DecisionUrl>
    <RefererUrl><![CDATA[https://my.paymentech.net/cbiWeb/displayDecision.do]]></RefererUrl>
  </Processor>
<Processor name=″firstdata″
type=″CB.Business.Implementation.Payment.FirstDataPaymentProcessor, CB.Business″ >
    </Processor>
  </PaymentProcessors>
```

Additional payment processors may be supported with a default plugin. The following steps need to be performed to support a new payment processor for commerce updation and file/letter creation steps using the default plugin. Table 25 presents an example for the Netgiro-SEB payment processor.

TABLE 25
Steps for adding additional payment processor with default plugin

| Step | Script |
|---|---|
| Add Workflow for the new | <Workflow mode=″netgiro-seb″> |
| payment processor under | <Process |
| workflows | type=″CB.Business.Implementation.Workflow.CommercePlatform |
| | WorkflowProcess, CB.Business″ /> |
| | <Process |
| | type=″CB.Business.Implementation.Workflow.LetterCreatorWork |
| | flowProcess, CB.Business″ /> |
| | </Workflow> |
| Add default plugin for the new | <Plugin mode =″netgiro-seb″> |
| payment processor | <Process |
| | type=″CB.Business.Implementation.Plugin.DefaultPlugin, |
| | CB.Business″ /> |
| | </Plugin> |
| Add supporting link type | <CardType key=″netgiro-seb″ value=″netgiro″></CardType> |
| Add supporting payment type | <PaymentType key=″netgiro-seb″ |
| | value=″netgiro″></PaymentType> |

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular physical components, user interface screens and code and architecture may vary depending on the particular system design, while maintaining substantially the same features and functionality and without departing from the scope and spirit of the present invention.

What is claimed is:

1. A chargeback dispute system comprising:
a centralized payment gateway for performing payment transactions and which receives a chargeback notification from a payment processor;
an ecommerce platform which stores electronic purchase order data; and
a chargeback dispute server, operatively coupled to the centralized payment gateway and the ecommerce platform, comprising software modules which when executed by a processor in the chargeback dispute server causes the server to perform chargeback operations of a job service, an administrative interface, a response creation program and a file transport program, collectively the chargeback operations create and transmit an automated chargeback dispute response to the payment processor based on the chargeback notification received from the centralized payment gateway and electronic purchase order data stored by the ecommerce platform.

2. The chargeback dispute system of claim 1 wherein the chargeback dispute system is integrated with a payment processor and communicates with an Application Programming Interface.

3. A method for addressing chargeback disputes comprising steps of:
receiving a chargeback notification at a centralized payment gateway from payment processor integrated with the centralized payment gateway;
obtaining the chargeback notification and associated payment information from the centralized payment gateway;
matching the chargeback notification to ecommerce transactions stored by an ecommerce platform and other transaction information including any additional order, fulfillment and shipping data related to the chargeback notification; and
creating an automated chargeback dispute response containing data required to investigate and challenge the chargeback notification; and
transmitting the automated chargeback dispute response to the payment processor.

4. The method for addressing chargeback disputes of claim 2 wherein the chargeback dispute response created in the creating step is in a form selected from a group consisting of: a letter, a file or API message.

5. The method for addressing chargeback disputes of claim 2 wherein the chargeback dispute response created in the creating step is transmitted to the payment processor in a manner selected from a group consisting of: email, File Transfer Protocol or Application Programming Interface.
